(19) United States
(12) Patent Application Publication
(10) Pub. No.: US 2009/0296388 A1
(43) Pub. Date: Dec. 3, 2009

(54) LED LIGHTING MODULE

(75) Inventors: WEI HUNG WU, KAOHSIUNG CITY (TW); CHIA CHEN CHANG, YILAN COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: ADVANCED OPTOELECTRONIC TECHNOLOGY INC., HSINCHU COUNTY (TW)

(21) Appl. No.: 12/473,189

(22) Filed: May 27, 2009

(30) Foreign Application Priority Data
Jun. 2, 2008 (TW) 097120424

(51) Int. Cl. F21S 4/00

(52) U.S. Cl. 362/235

(57) ABSTRACT

An LED lighting module comprises an array luminous element and a bar-like light guiding structure. The array luminous element comprises a plurality of illuminants of top-emitting LEDs arranged in an array form. The bar-like light guiding structure surrounds two laterals of the array luminous element. The bar-like light guiding structure comprises a first curved surface and a second curved surface. The first curved surface and the second curved surface respectively descend toward the middle of the array luminous element from the two sides of the array luminous element, and meet above the middle of the array luminous element. The first curved surface and the second curved surface connect with each other at the plane with a certain angle and in tangency where the positive optical axis exists. The positive optical axis is the direction perpendicular to the plane on which the LEDs are mounted.

### BACKGROUND OF THE INVENTION

(A) Field of the Invention

The present invention relates to an LED (light emitting diode) lighting module, and more particularly, to an LED lighting module which is bar-like and side-emitting.

(B) Description of the Related Art

The light emitting diode (LED) offers several advantages over previous light sources including low energy consumption, high efficiency, long lifetime and low environmental pollution (e.g., mercury-free construction), and is generally applied to the back light modules of various flat displays for excellent color expression. Therefore, the use of LEDs in flat-screen display applications is of high importance, and the related technology is developing rapidly.

Back light modules are classified according to the position of the light source, the main classifications being a side type and a direct type. Currently, LCDs (liquid crystal display) are mainly applied to notebook computers and LCD monitors whose back light modules are particularly required to be light, small and thin. The side type modules can meet the aforesaid requirements. By contrast, design considerations for the back light module of LCD TV applications of larger size must focus on meeting requirements of sufficient brightness, wide view angle, sharp image contrast and long working life. In view of the aforesaid considerations, the direct type is the current trend in the large scale LCD.

As shown in FIG. 1A, U.S. Pat. No. 6,679,621 provides an LED having a lens structure for a side-emitting light source. In contrast to conventional CCFL backlight modules, the side type light source further provides a backlight source for an LCD which comprises a plurality of LEDs with side-emitting lenses arranged in a matrix. The lens according to U.S. Pat. No. 6,679,621 comprises a funnel-shaped reflecting surface, a first refracting surface, and a second refracting surface. A certain included angle exists between the reflecting surface and the positive optical axis of the LED so that the reflecting surface can reflect light emitted from an LED die. The first refracting surface has an inclined angle relative to the positive optical axis of the LED so that the first refracting surface can refract the reflected light directed from the reflecting surface. The second refracting surface is a convex curved surface or a saw-toothed surface extending from the first refracting surface to the base of the LED. The first refracting surface connects the reflecting surface and the second refracting surface.

As shown in FIG. 1A, the profile of the lens is not easy to shape, and cannot be accurately formed to precisely match its design. Furthermore, the LED is a small scale device, and hence, such complicated lens is more difficult to form on such a device. In order to have a side emitting backlight module, each LED must have such a complicated lens. The requirement of such complicated lenses demands sophisticated processes and high manufacturing costs. Therefore, such LEDs are not suitable for mass production. In some embodiments, an additional waterproof apparatus is needed to assure the reliability of the product.

In view of the above, there is an urgent need for an advanced photoelectric device for side-emitting LED structures. With such a device, the side emitting LED lighting module could be successfully mass produced. In addition, the light guide profile would be improved, and the manufacturing cost reduced.

### SUMMARY OF THE INVENTION

One aspect of the present invention provides an economical and effective LED lighting module capable of laterally emitting light. Such an LED lighting module is applicable to illumination apparatuses for effectively outputting indirect light. The original lighting area of an LED, a point light source, is increased through the operation of the LED lighting module. Accordingly, the occurrence of flares is reduced. Such an LED lighting module can be applied to advertising display apparatuses, and a uniform surface light source is easily obtained for improving display quality. The LED lighting module of the present invention is also applicable to the backlight module of an LCD.

The present invention provides an LED lighting module comprising an array luminous element and a bar-like light guiding structure. The array luminous element comprises a plurality of illuminants of top-emitting LEDs arranged in an array form. The bar-like light guiding structure surrounds two laterals of the array luminous element. The bar-like light guiding structure comprises a first curved surface and a second curved surface. The first curved surface and the second curved surface respectively descend toward the middle of the array luminous element from the two sides of the array luminous element, and meet above the middle of the array luminous element. The first curved surface and the second curved surface connect with each other at the plane with a certain angle and in tangency where the positive optical axis exists. The positive optical axis is the direction perpendicular to the plane on which the LEDs are mounted.

### BRIEF DESCRIPTION OF THE DRAWINGS

The objectives and advantages of the present invention will become apparent upon reading the following description and upon reference to the accompanying drawings in which:

FIG. 1A is a schematic diagram of an LED having a lens structure for side emitting disclosed by U.S. Pat. No. 6,679,621;

FIG. 1B is a schematic diagram of a lighting source of a backlight module employing LEDs disclosed by Taiwan Patent No. 1244227;

FIG. 1C is a schematic diagram of an LED tube with a wide emitting angle disclosed by Taiwan Patent No. M272924;

FIG. 1D is a schematic diagram of an LED array element for a backlight unit disclosed by China Invention Patent No. 1693960;

FIG. 1E is a schematic diagram of a side-emitting LED lighting device disclosed by China Invention Patent No. 1779530;

FIG. 1F is a schematic diagram of an LED module redirecting the traveling direction of light disclosed by U.S. publication Patent No. 2006262538;

FIG. 1G is a schematic diagram of a side-emitting LED device having diffusing lens disclosed by U.S. Pat. No. 7,224,537;

FIG. 2A is a schematic diagram of an LED light module 200a in accordance with the present invention;

FIG. 2B is a schematic diagram of an LED light module 200a having a heat dissipation structure and a supporting structure in accordance with the present invention;

FIG. 2C is a schematic diagram of an LED light module 200a having LED light sources arranged in three rows in accordance with the present invention;

FIG. 2D is a schematic diagram of an LED light module 200a having reflecting plates beside each LED lighting bar in accordance with the present invention;

FIGS. 2E-2H are schematic cross-section diagrams illustrating bar-like light guiding structures with various profiles in accordance with the present invention;

FIG. 21 is a schematic diagram illustrating the paths of output light emitted from an LED and reflected toward its two sides in accordance with the present invention;

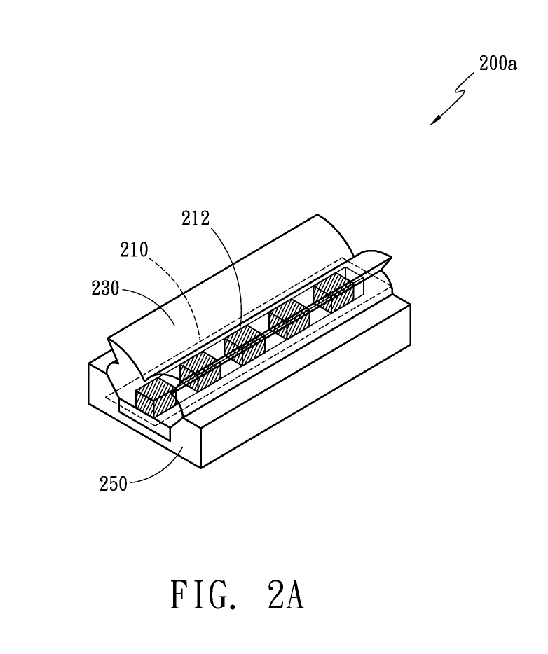

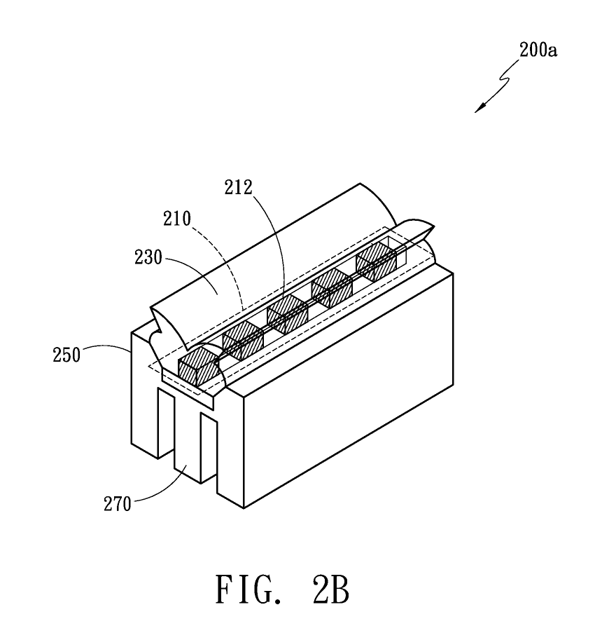

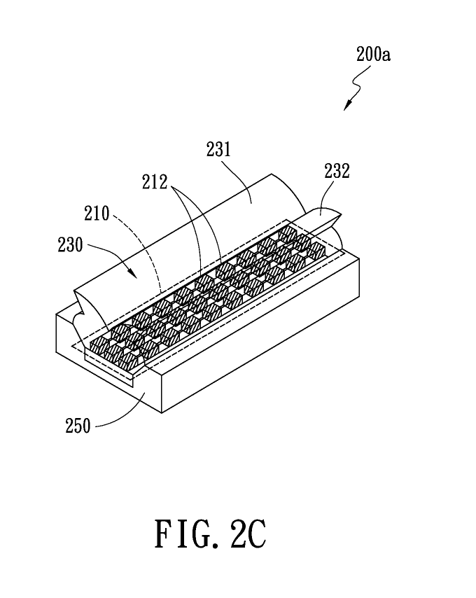

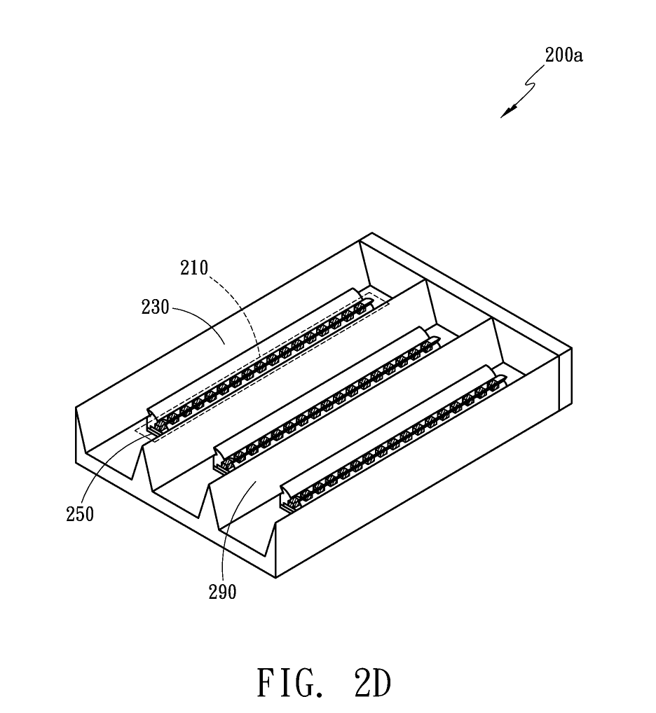

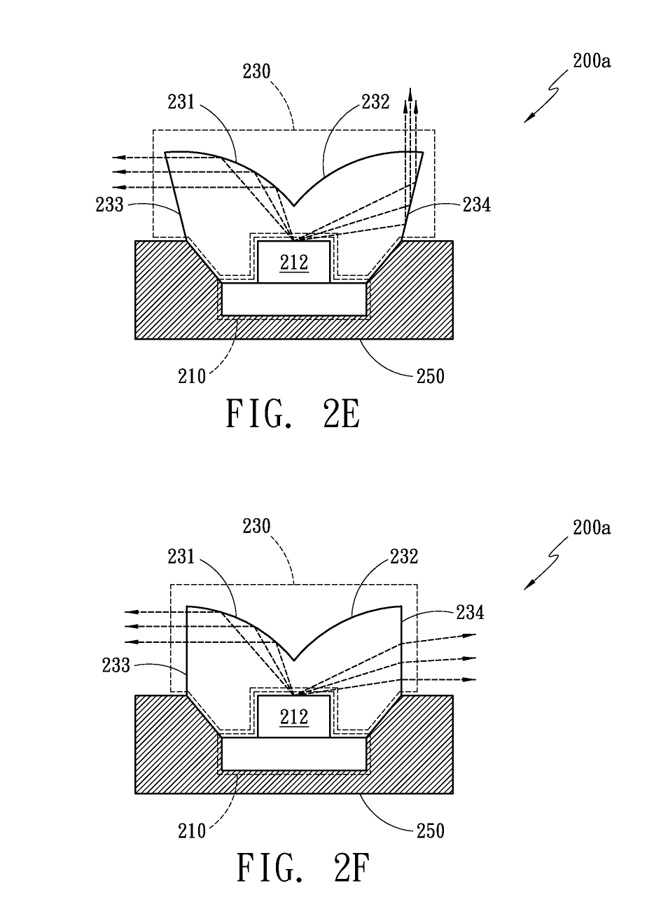

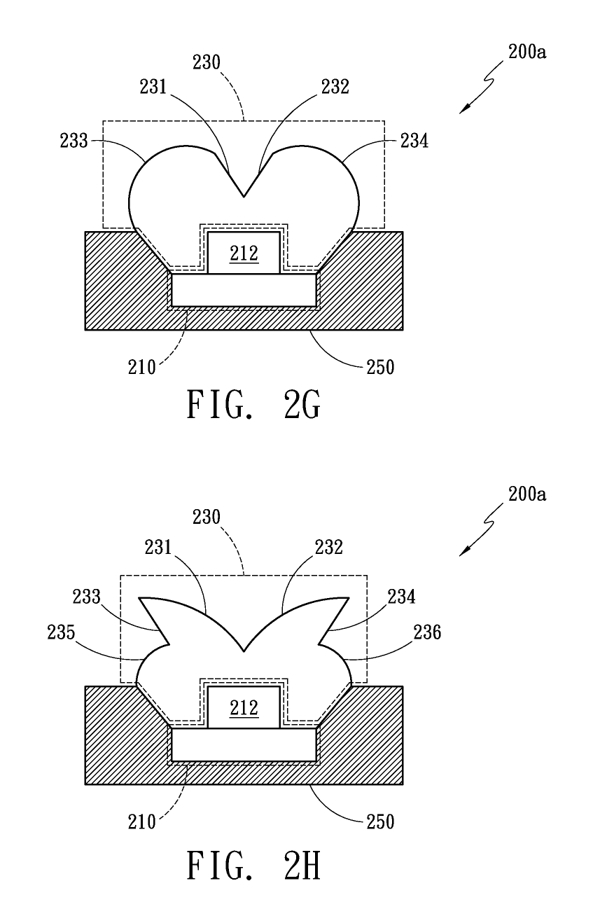

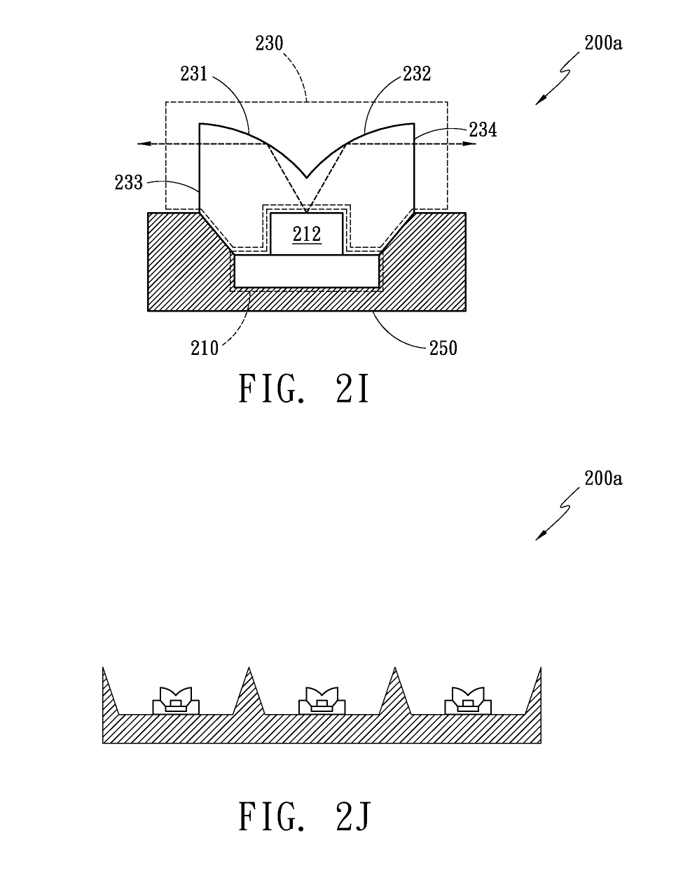

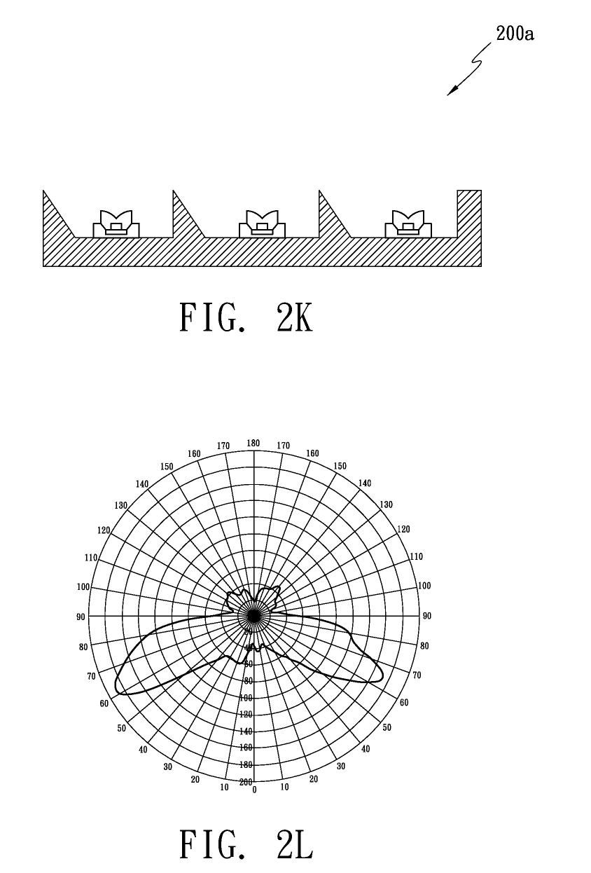

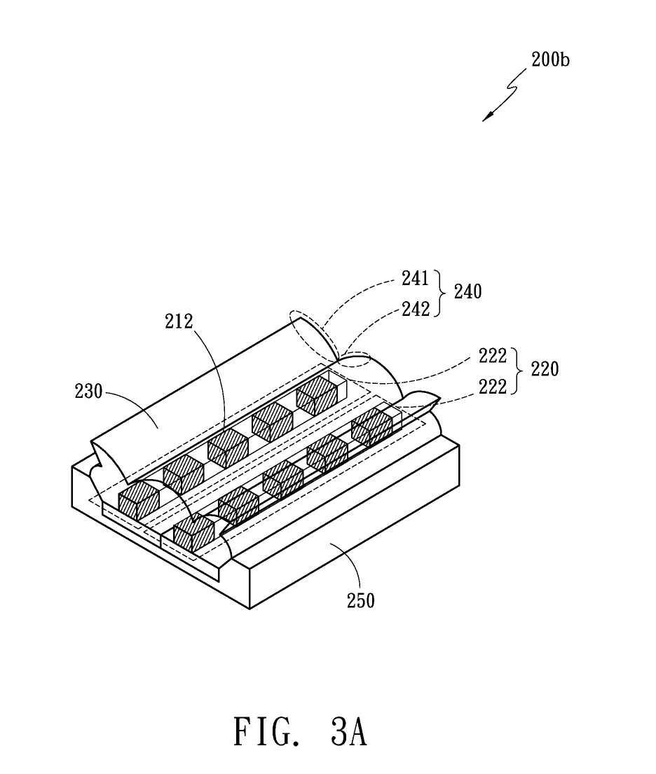

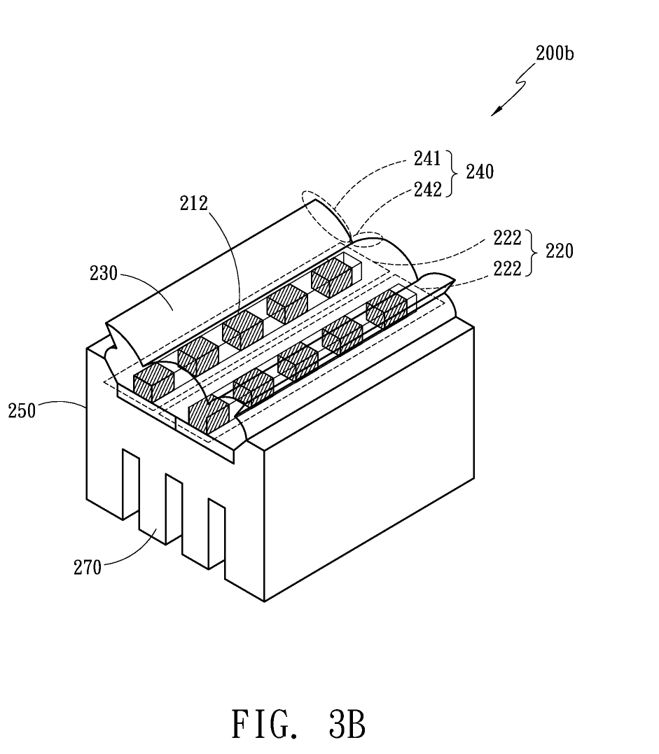

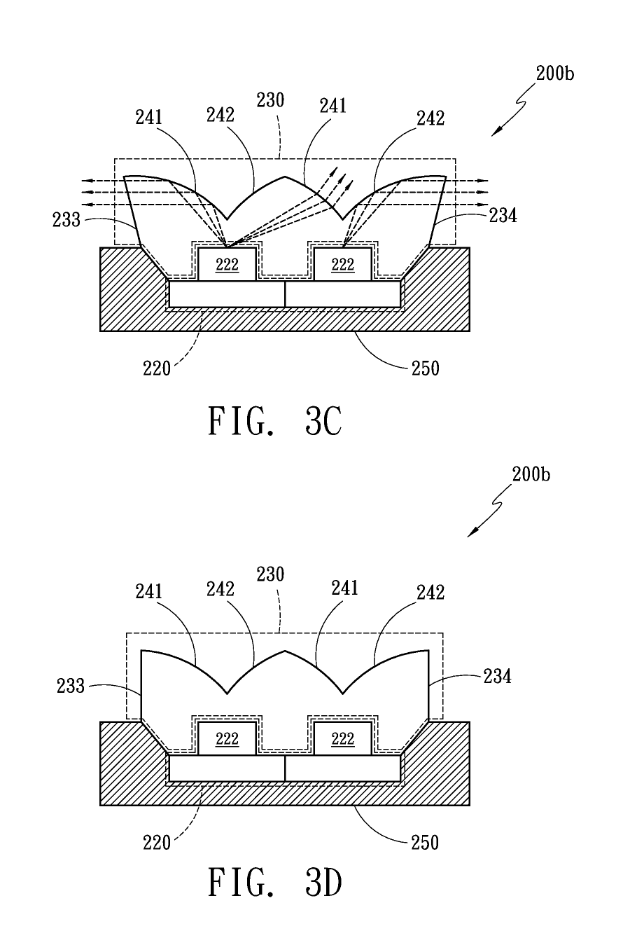

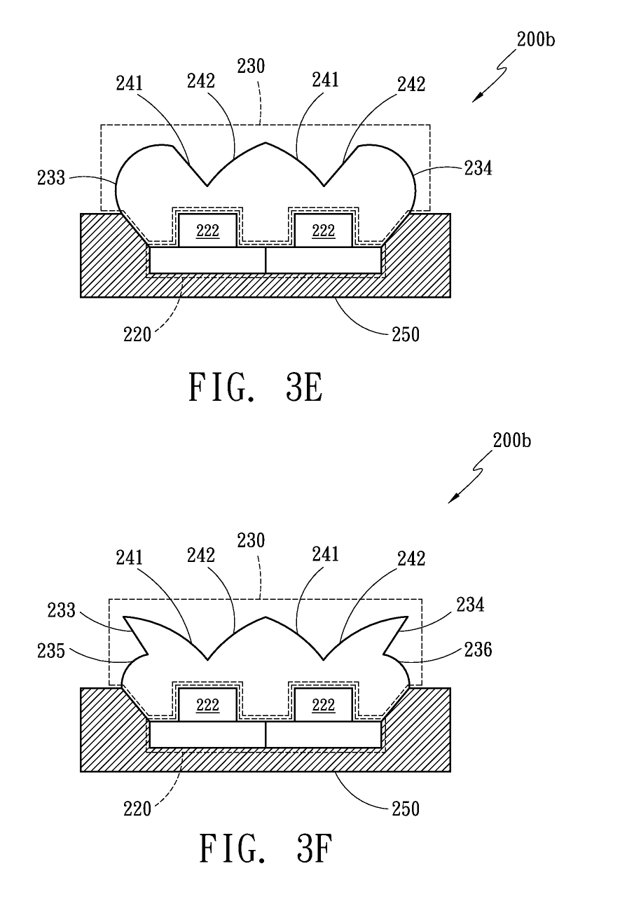

FIG. 2J is a schematic cross-section diagram of an LED light module 200a with reflecting plates (two slanted plates) in accordance with the present invention;

FIG. 2K is a schematic cross-section diagram of an LED light module 200a with reflecting plates (one slanted plate and one vertical plate) in accordance with the present invention;

FIG. 2L is a distribution diagram of light intensity versus angular displacement of an LED light module 200a with side-emitting capability in accordance with the present invention;

FIG. 3A is a schematic diagram of an LED light module 200b in accordance with another embodiment of the present invention;

FIG. 3B is a schematic diagram of an LED light module 200b having a heat dissipation structure and a supporting structure in accordance with an embodiment of the present invention;

FIGS. 3C-3F are schematic cross-section diagrams illustrating bar-like light guiding structures with various profiles in accordance with other embodiments of the present invention;

FIG. 3G is a schematic cross-section diagram of an LED light module 200b with reflecting plates (two slanted plates) in accordance with another embodiment of the present invention; and

FIG. 3H is a schematic cross-section diagram of an LED light module 200b with reflecting plates (one slanted plate and one vertical plate) in accordance with another embodiment of the present invention.

### DETAILED DESCRIPTION OF THE INVENTION

The present invention provides an LED (light emitting diode) lighting module. For complete understanding of the present invention, the following description will present in detail the manufacturing steps and the composition. The present invention is not limited by the specified particulars of a backlight module that are familiar to persons skilled in the art. In addition, well-known compositions or steps are not described in detail so as to avoid any additional limitation. The preferable embodiments of the present invention are described in detail. In addition to the detailed descriptions, the present invention also can be applied to other embodiments. Therefore, the scope of the present invention is not limited, and is dependent on the following claims.

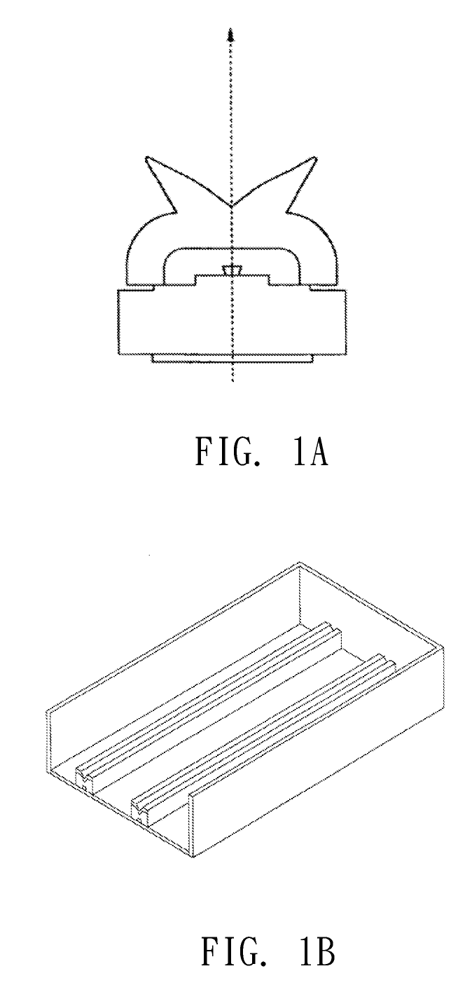

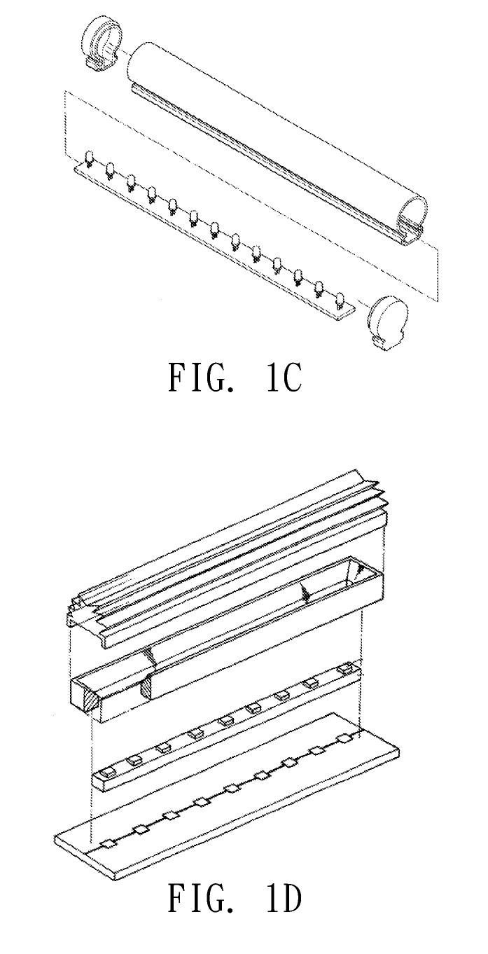

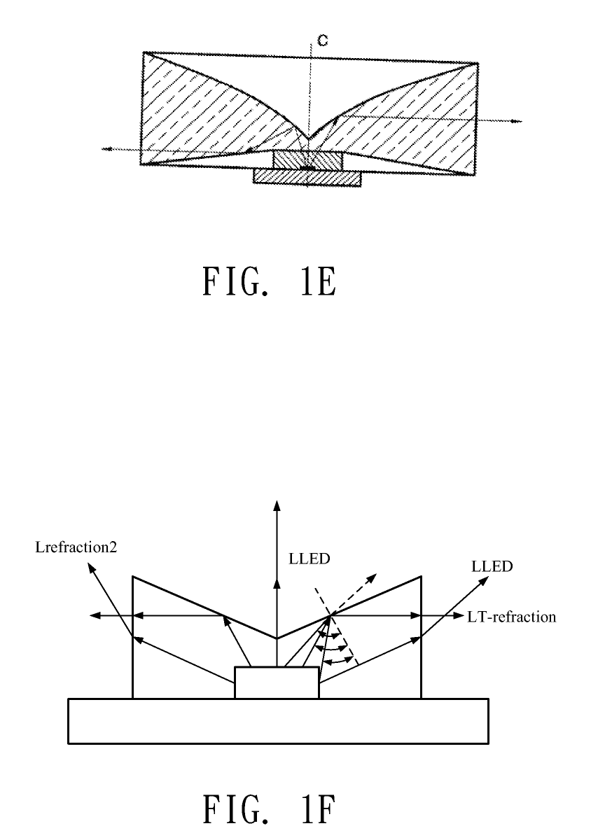

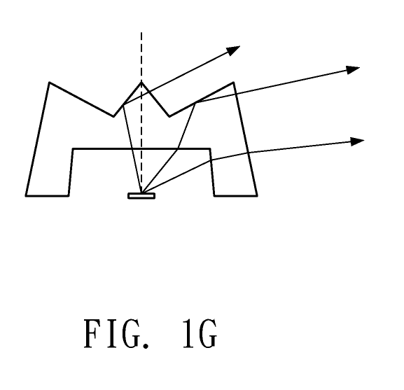

Taiwan Patent No. 1244227 discloses a lighting source of a backlight module employing LEDs. The lighting source employs LEDs with a COB (chip on board) package type. That is, LED dies are directly mounted on substrates. The LED lighting module comprises a main lamp box capable of reflecting light. The lamp box comprises four side walls and a bottom surface. A plurality of bare LED dies is directly mounted on a heat-dissipation substrate, and is arranged in a two-line matrix. Each of the two LED lines is covered by a light housing. The light housing can direct light in a lateral direction. The lateral light travels in the interior of the main lamp box and is mixed to have a uniform planar light source, as shown in FIG. 1B. However, the mixed light has a poor directivity. Accordingly, an additional brightness enhancement film is needed to dispose on the main lamp box for improving optical performance.

Taiwan Patent No. M272924 discloses an LED tube with a wide emitting angle, as shown in FIG. 1C. The LED tube comprises a slender sheet-like circuit board with a plurality of LEDs which are arranged in a line and disposed thereof. A transparent cover surrounds the LED tube. The cover is a hollow cylindrical tube. The LED tube disclosed in the prior art has no optical characteristics, and is used to protect the LED lighting bar and simplify the appearance of the LED lighting bar.

China Invention Patent No. 1693960 discloses a backlight unit having an LED array element. FIG. 1D shows a decomposition chart of the LED array element. The LED array element has a rectangular reflector surrounding a plurality of LEDs arranged in a line as a lighting bar. The light emitted upwards from the LEDs is reflected by the reflector. A lens is disposed above the reflector and the LED lighting bar. Through the lens scatters, the light from the LEDs and the reflector,can be emitted outwardly and horizontally. However, the reflector has a rectangular body with a certain dimension, so the practical application is quite limited.

China Invention Patent No. 1779530 discloses a side-emitting LED lighting device which can be applied to the backlight module of an LCD. As shown in FIG. 1E, the device comprises a first reflecting surface, a second reflecting surface and a refracting surface. The first reflecting surface is a conical surface surrounding and centering the positive optical axis of the LED. The second reflecting surface surrounds the LED to form a conical surface. The second reflecting surface connects the LED and the refracting surface. The refracting surface connects the first reflecting surface and the second reflecting surface. As with the aforesaid U.S. Pat. No. 6,679,621, the side-emitting LED lighting device of this prior art is for a single LED device to provide lateral light. In view of the prior art, each of the LEDs included in a side-emitting backlight module needs to be mounted with a complicated reflector thereon. Furthermore, the conical reflecting surfaces are difficult to form, so the manufacturing processes are complicated and the cost is high. It is not suitable for mass production.

U.S. publication Patent No. 2006262538 discloses an LED module redirecting light. As shown in FIG. 1F, the module has a unit for redirecting light comprising two slanting reflecting plates and two reflecting surfaces. The aforesaid two slanting reflecting plates center the positive optical axis of the LED to form a V-shaped surface. The refracting surface connects the reflecting plate and the circuit board. The LED is mounted on the circuit board. In addition, two slanting reflecting plates can also form a V-shaped curved surface, or a conical surface is formed between the reflecting surfaces. The prior art also proposes the structures as follows: In view of this prior art, the aforesaid unit for redirecting light is disposed on a single LED device. Furthermore, when a plurality of LEDs arranged in a matrix are mounted on a circuit board, the unit for redirecting light can also be formed on the LEDs arranged in a matrix. Accordingly, the unit for redirecting light comprises a plurality of V-shaped surfaces, V-shaped curved surfaces or independent conical surfaces respectively and correspondingly arranged above each of the LEDs.

U.S. Pat. No. 7,224,537 discloses a side-emitting LED device having diffusing lens, as shown in the side view of FIG. 1G. It is similar to U.S. Pat. No. 6,679,621. The side-emitting LED device comprises a small triangular conical reflecting surface centering the positive optical axis of the LED, and another triangular conical reflecting surface surrounding the aforesaid triangular conical reflecting surface. The refracting surface connects the bottom surface and the conical reflecting surface. In view of the prior art, the reflecting surfaces and the refracting surface are all flat surfaces and so are more easily fabricated in comparison with U.S. Pat. No. 6,679,221.

However, most of the aforesaid prior arts propose side-emitting structures applied to only a single LED device. In contrast, a backlight module comprising a plurality of such LED devices requires complicated manufacturing processes and incurs high manufacturing costs. Therefore, the present invention provides an economical and effective LED lighting module capable of laterally emitting light. The module is easily assembled, and has no limitation on its dimensions. The problems of each LED requiring complicated manufacturing processes and incurring high manufacturing costs are resolved.

The present invention provides an LED lighting module 200a, as shown in FIG. 2A. The LED lighting module 200a comprises an array luminous element 210 and a bar-like light guiding structure 230. The array luminous element 210 comprises a plurality of illuminants of top-emitting LEDs 212 arranged in an array form. The bar-like light guiding structure 230 disposes on two laterals of the array luminous element 210. The aforesaid LEDs 212 are top emitting light sources, wherein the LEDs are chips in package. The LEDs 212 of the array luminous element 210 are arranged in a line or in an array with a plurality of lines. FIG. 2C shows a perspective diagram of the LED lighting module 200a comprising three LED lines. The aforesaid bar-like light guiding structure 230 comprises a first curved surface 231 and a second curved surface 232. The first curved surface 231 and the second curved surface 232 respectively descend toward the middle of the array luminous element 210 from the two sides of the array luminous element 210, and meet above the middle of the array luminous element 210. The first curved surface 231 and the second curved surface 232 connect at the plane with a certain angle and in tangency where the positive optical axis of the array luminous element 210 exists. The positive optical axis is perpendicular to the plane on which the LEDs 212 are mounted.

The bar-like light guiding structure 230 of the present invention further comprises a plurality of geometric light guide surfaces (see references 233-236 in FIGS. 2E-2H). The geometric light guide surfaces respectively connect the array luminous element 210, the first curved surface 231 and the second curved surface 232 to form the bar-like light guiding structure 230. As shown in FIG. 2E, one side of the geometric light guide surface 233 connects to the first curved surface 231. Another geometric light guide surface connects the geometric light guide surface 233 and the array luminous element 210. The first curved surface 231, the second curved surface 232, and the geometric light guide surfaces 233-236 are lenses or inner surfaces coated with a reflecting material. The inner surfaces are defined as the surfaces of the first curved surface 231, the second curved surface 232, or the geometric light guide surfaces adjacent to the LEDs 212. The geometric light guide surface is one of a semicircular surface, a vertical plane, a slanting plane and a curved surface or the combination of the aforesaid several surfaces.

The present invention provides a reflecting plate 290 disposed on a side of the bar-like light guiding structure 230. Alternatively, the reflecting plates 290 may be disposed on two opposite sides of the bar-like light guiding structure 230, as shown in FIG. 2D. The reflecting plate 290 reflects the side light reflected and refracted by the bar-like light guiding structure 230 in a direction perpendicular to or parallel to the positive optical axis of the array luminous element 210.

The present invention provides four types of the bar-like light guiding structure 230 with various geometric profiles. All four figures of FIG. 2E, FIG. 2F, FIG. 2G, FIG. 2H show cross-section diagrams of the bar-like light guiding structures 230 with various geometric profiles. The light emitted from the LEDs 212 is totally reflected, partially reflected, or refracted by the first curved surface 231, the second curved surface 232, or each of the geometric light guide surfaces in a direction perpendicular to or parallel to the positive optical axis of the array luminous element 210. The side emitting light redirected by the bar-like light guiding structures 230 emits towards the aforesaid reflecting plate 290. The reflecting plate 290 partially reflects or totally reflects the side emitting light again to produce a top emitting light. The light is emitted from the LEDs, and then is processed by the aforesaid light guide to obtain indirect light which is suitable for illumination use. Accordingly, the occurrence of flares is reduced. Such an LED lighting module is applied to advertising display apparatuses, and a uniform surface light source is easily obtained for improving display quality.

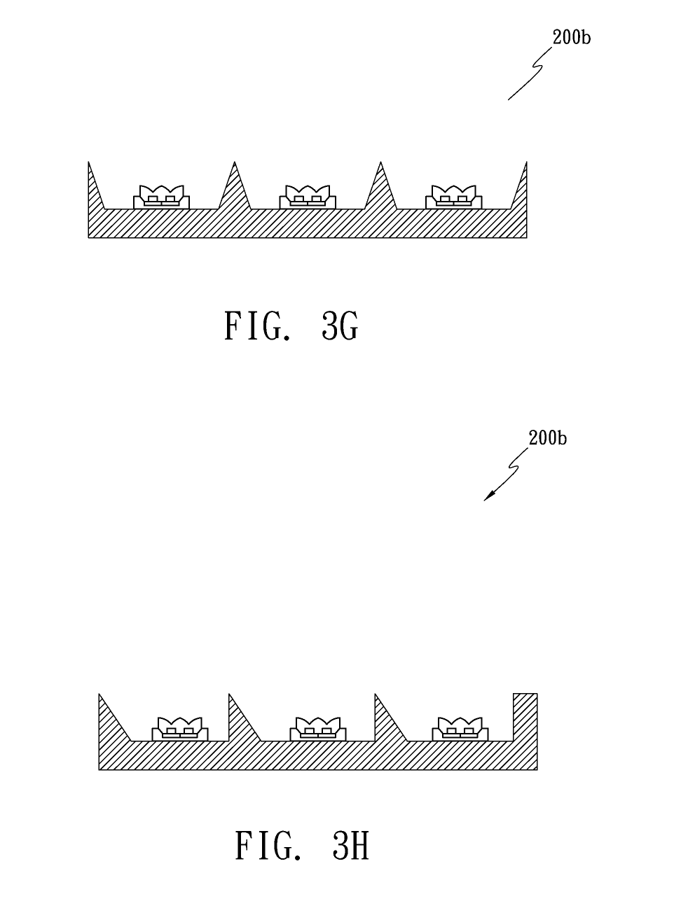

The bar-like light guiding structures 230 of the present invention propose several combinations of various light guide surfaces and various light guiding models, including but not limited to the following exemplary combinations. In a first combination, the first curved surface 231 and the second curved surface 232 are coated with a total reflective material. After the light is partially reflected or totally reflected by the first curved surface 231 and the second curved surface 232, the light is redirected to form side lights projecting on two opposite sides. The geometric light guide surfaces 233 and 234 direct the side light to the outside. As shown in FIG. 21, the dashed line represents the light path. Referring to the graph of FIG. 2L, the distribution diagram of light intensity versus angular displacement shows the side light of this first combination has maximum intensity at the angle between about 60°-70° relative to the positive optical axis (0°). In the second combination, the first curved surface 231 and the second curved surface 232 are coated with a reflective material. The geometric light guide surfaces adjacent to the first curved surface 231 and the second curved surface 232 are also coated with a reflective material. As shown in FIG. 2E, the dashed line represents the light path. After the light is partially reflected or totally reflected by the first curved surface 231, the light is redirected to form a side light. The side light is directed by the geometric light guide surface 233 to the outside. The light emitted towards the geometric light guide surface 234 is partially reflected or totally reflected to form a top light. The top light is reflected by the second curved surface 232 for compensating the previously mentioned top light. In the third combination, the first curved surface 231 and the second curved surface 232 are coated with a total reflective material. As shown in FIG. 2F, the dashed line represents the light path. After the light is partially reflected or totally reflected by the first curved surface 231, the light is redirected to form a side light. The light emitted towards the geometric light guide surface 234 is reflected to form another side light opposite the previous side light.

In the first and third light guide combinations, after the light guide processing, the original light is redirected to be side lights towards two opposite sides. In these embodiments, the reflecting plates are two slanted plates. The slanted plates incline towards the LEDs from two opposite outsides of the bar-like light guiding structures 230, as shown in the cross-section diagram of the reflecting plates of FIG. 2J. In the second light guide combination, the reflecting plates comprise a slanted plate and a vertical plate. FIG. 2K shows a cross-section diagram of such reflecting plates.

The present invention further provides a supporting base 250. As shown in FIG. 2A, the supporting base 250 is disposed under and on either side of the array luminous element 210 and the bar-like light guiding structure 230. The supporting base 250 can support and fix the array luminous element 210 and the bar-like light guiding structure 230 so that they can be effectively combined with each other.

The present invention further provides a thermal dissipation device 270, as shown in FIG. 2B. The thermal dissipation device 270 is disposed under the supporting base 250. In another embodiment, the supporting base 250 is removed and the thermal dissipation device 270 is disposed directly under the array luminous element 210. The thermal dissipation device 270 comprises a plurality of thermal dissipation fins. The fins are directed opposite the top emitting direction of the LEDs 212. In a preferable embodiment, the thermal dissipation device 270 can be integrated with the supporting base 250.

The present invention provides an economical and effective LED lighting module capable of laterally emitting light. The bar-like light guiding structure is mounted on a top emitting LED lighting bar so as to achieve the aforesaid objectives. The assembly of the LED lighting module is as follows: providing a supporting base 250 on which the array luminous element 210 is disposed; and embedding a bar-like light guiding structure 230 into the supporting base 250 from the lateral groove of the supporting base 250. The top emitting LED lighting module is not limited in dimensions. The length and width of the module can be adjusted according to its practical need. The present invention resolves the problems of complicated manufacturing processes and high costs resulting from the need for each of the LEDs to have a light guide lens mounted thereon. Furthermore, the aforesaid bar-like light guiding structure can also act as a waterproof device for the LED lighting bar. In addition, the integration of the thermal dissipation device 270 and the supporting base 250 resolves the defects of the prior arts in which lighting module and thermal dissipation module are individual parts.

As shown in FIG. 3A, the present invention provides another LED lighting module 200b comprising a lighting component 220 and a bar-like light guiding structure 230. The lighting component 220 comprises a plurality of bar-like LED components 222, each of which has top emitting LEDs aligned. The bar-like light guiding structure 230 comprises a plurality of V-shaped light guide surfaces 240.

Each of the V-shaped light guide surfaces 240 comprises two curved surfaces 241 and 242 which meet above the middle of the bar-like LED component 222. The curved surface 241 and the curved surface 242 connect at the plane with a certain angle and in tangency where the positive optical axis of the bar-like LED component 222 exists. The curved surface 241 and the curved surface 242 are lenses or have inner surfaces coated with a reflecting material. The inner surfaces are defined as the surfaces of the curved surface 241 and the curved surface 242 adjacent to the LED lighting sources 212.

The bar-like light guiding structure 230 further comprises a plurality of geometric light guide surfaces (see references 233-236 in FIG. 3C to FIG. 3F). The aforesaid geometric light guide surfaces 233-236 respectively connect the lighting component 220 and the outermost surfaces of the bar-like light guiding structure 230. The geometric light guide surfaces 233-236 are lenses or inner surfaces coated with a reflecting material. The inner surfaces are a surface of the geometric light guide surfaces adjacent to the LED lighting sources. Each of the geometric light guide surfaces 233-236 is one of a semicircular surface, a vertical plane, a slanting plane and a curved surface.

The present invention provides four kinds of the bar-like light guiding structure 230 with various geometric profiles. All four figures of FIG. 3C, FIG. 3D, FIG. 3E, FIG. 3F show cross-section diagrams of the bar-like light guiding structures 230 with various geometric profiles. The light emitted from the LED lighting sources 212 is totally reflected, partially reflected or refracted by the curved surface 241, the curved surface 242, or each of the geometric light guide surfaces 233-236 in a direction perpendicular to or parallel to the positive optical axis of the bar-like LED component 222. As shown in FIG. 3C, the dashed line represents the light path.

The present invention provides a reflecting plate 290 disposed on a side of the bar-like light guiding structure 230. In another embodiment, the reflecting plates 290 are disposed on two opposite sides of the bar-like light guiding structure 230. In this embodiment, the reflecting plates comprise two slanted plates or a slanted plate and a vertical plate, as shown in FIGS. 3G-3H. The reflecting plates 290 reflects the side light reflected and refracted by the bar-like light guiding structure 230 in a direction perpendicular to or parallel to the positive optical axis of the bar-like LED component 222.

The present invention further provides a supporting base 250. Referring to FIG. 3A, the supporting base 250 is disposed under and on two sides of the lighting component 220 and the bar-like light guiding structure 230. The supporting base 250 can support and fix the array lighting component 220 and the bar-like light guiding structure 230.

The present invention further provides a thermal dissipation device 270, as shown in FIG. 3B. The thermal dissipation device 270 is disposed under the supporting base 250. In another embodiment, the supporting base 250 is removed and the thermal dissipation device 270 is disposed directly under the array lighting component 220. The thermal dissipation device 270 comprises a plurality of thermal dissipation fins. The fins are directed opposite the top emitting direction of the LED lighting sources 212. In a preferable embodiment, the thermal dissipation device 270 can be integrated with the supporting base 250.

The present invention provides an economical and effective LED lighting module capable of laterally emitting light. Such an LED lighting module is applicable to illumination apparatuses for effectively outputting indirect light. Accordingly, the occurrence of flares is reduced. Such an LED lighting module can be applied to advertising display apparatuses, and a uniform surface light source is easily obtained for improving display quality. The LED lighting module of the present invention is also applicable to the backlight module of an LCD display apparatus.

The above-described embodiments of the present invention are meant to be illustrative and not limiting. It will thus be obvious to those skilled in the art that various changes and modifications may be made without departing from this invention in its broader aspects. Therefore, the appended claims encompass all such changes and modifications as falling within the true spirit and scope of this invention.

What is claimed is:

1. A light emitting diode (LED) lighting module, comprising:
an array luminous element including a plurality of top emitting LEDs which are arranged into an array; and
a bar-like light guiding structure disposed on both sides of the array luminous element, the bar-like light guiding structure including a first curved surface and a second curved surface, the first curved surface and the second curved surface respectively descending toward the middle of the array luminous element from the sides of the array luminous element to meet above the middle of the array luminous element, wherein the first curved surface and the second curved surface connect at a certain angle and in tangency on a plane where the positive optical axis of the array luminous element exists, and the positive optical axis is the direction perpendicular to a plane on which the LEDs are mounted.

2. The LED lighting module of claim 1, wherein the first curved surface and the second curved surface are both lenses or inner surfaces coated with reflecting materials, wherein the inner surfaces are surfaces adjacent to the LEDs.

3. The LED lighting module of claim 1, wherein the bar-like light guiding structure includes a plurality of geometric light guide surfaces respectively connecting the array luminous element, the first curved surface and the second curved surface.

4. The LED lighting module of claim 3, wherein each of the plurality of geometric light guide surfaces is a lens or an inner surface coated with a reflecting material, and the inner surface is a surface of the geometric light guide surface adjacent to the LEDs, wherein each of the plurality of light guide geometric surfaces is one of a semicircular surface, a vertical plane, a slanted plane and a curved surface or a combination of the aforesaid several surfaces or planes.

5. The LED lighting module of claim 1, further comprising a thermal dissipation device disposed under a portion of the array luminous element, wherein the thermal dissipation device includes a plurality of thermal dissipation fins, and each opening between the plurality of thermal dissipation fins extends towards the direction opposite the top emitting direction of the LEDs.

6. The LED lighting module of claim 5, further comprising a supporting base disposed under a portion of and outsides of the array luminous element and the bar-like light guiding structure, wherein the supporting base is integrated with the thermal dissipation device, and the supporting base supports and fixes the array luminous element and the bar-like light guiding structure.

7. The LED lighting module of claim 1, wherein the top emitting LEDs of the array luminous element is arranged in a single line or an array with a plurality of lines.

8. The LED lighting module of claim 1, wherein the bar-like light guiding structure directs light perpendicular to or parallel to the positive optical axis of the array luminous element through total reflection, partial reflection, or refraction.

9. The LED lighting module of claim 1, further comprising a reflecting plate disposed on two opposite sides of the bar-like light guiding structure, wherein the reflecting plate reflects lateral light from the bar-like light guiding structure in a direction perpendicular to or parallel to the positive optical axis of the array luminous element through reflection or refraction.

10. The LED lighting module of claim 1, wherein the LED lighting module is applied to a backlight source of a liquid crystal device (LCD), an illumination apparatus, or a commercial display apparatus.

11. An LED lighting module, comprising:
an array luminous element including a plurality of top emitting LEDs arranged into an array; and
a bar-like light guiding structure disposed on both sides of the array luminous element, the bar-like light guiding structure including a first curved surface, a second curved surface, and a plurality of geometric light guide surfaces; the plurality of geometric light guide surfaces respectively connecting the array luminous element, the first curved surface, and the second curved surface; the first curved surface and the second curved surface respectively descending toward the middle of the array luminous element from the sides of the array luminous element to meet above the middle of the array luminous element, wherein the first curved surface and the second curved surface connect at a certain angle and in tangency on a plane where the positive optical axis of the array luminous element exists; and the positive optical axis is the direction perpendicular to a plane where the LEDs are mounted.

12. The LED lighting module of claim 11, wherein the first curved surface, the second curved surface, or one of the plurality of geometric light guide surfaces is a lens or an inner surface coated with a reflecting material.

13. The LED lighting module of claim 11, further comprising a reflecting plate disposed on two opposite sides of the bar-like light guiding structure, wherein the reflecting plate reflects lateral light from the bar-like light guiding structure in a direction perpendicular to or parallel to the positive optical axis of the array luminous element through reflection or refraction.

14. An LED lighting module, comprising:
a luminous element including a plurality of top emitting LED components which have strip profiles; and
a bar-like light guiding structure including a plurality of V-shaped light guide plates, each of the V-shape light guide plates composed of two curved surfaces, the two curved surfaces connecting above the middle of the plurality of top emitting LED components, wherein the two curved surfaces connect at a certain angle and in tangency on a plane where the positive optical axis of the luminous element exists, and an adjacent pair of the V-shaped light guide plates meet at a plane where an adjacent pair of the top emitting LED components connect.

15. The LED lighting module of claim 14, wherein each of the two curved surfaces is a lens or an inner surface coated with a reflecting material, and the inner surface is a surface of the first curved surface adjacent to the top emitting LED components.

16. The LED lighting module of claim 14, wherein the bar-like light guiding structure further comprises a plurality of geometric light guide surfaces respectively connecting the outermost curved surfaces of the luminous element and the bar-like light guiding structure, the geometric light guiding surfaces is a lens or an inner surface coated with a reflecting material, and the inner surface is a surface of the first curved surface adjacent to the luminous element, and each of the plurality of light guide geometric surfaces is one of a semicircular surface, a vertical plane, a slant plane and a curved surface or a combination of the aforesaid several surfaces and planes.

17. The LED lighting module of claim 14, further comprising a reflecting plate disposed on one side or opposite sides of the bar-like light guiding structure, wherein said reflecting plate reflects lateral light from the bar-like light guiding structure in a direction perpendicular to or parallel to the positive optical axis of the luminous element through reflection or refraction.

18. The LED lighting module of claim 14, further comprising a supporting base disposed under a portion of and outsides of the luminous element and the bar-like light guiding structure, wherein the supporting base is integrated with the thermal dissipation device, and the supporting base supports and fixes the luminous element and the bar-like light guiding structure.

19. The LED lighting module of claim 18, further comprising a thermal dissipation device disposed under a portion of the supporting base, wherein the thermal dissipation device includes a plurality of thermal dissipation fins, and each opening between the plurality of thermal dissipation fins extends towards the direction opposite the top emitting direction of the LED components.

20. The LED lighting module of claim 14, further comprising a thermal dissipation device disposed under a portion of and outsides of the luminous element and the bar-like light guiding structure, wherein the thermal dissipation device includes a plurality of thermal dissipation fins.
